(19) United States
(12) Patent Application Publication
(10) Pub. No.: US 2026/0275027 A1
(43) Pub. Date: Sep. 17, 2026

(54) POLY(HEXAPHENYL-M,P-QUATERPHENYLENE) AND METHODS OF MAKING THEREOF

(71) Applicant: IOWA STATE UNIVERSITY RESEARCH FOUNDATION, INC., Ames, IA (US)

(72) Inventors: Bradley A. SWAN, Ankeny, IA (US); Christopher J. CORNELIUS, Ames, IA (US); Michael A. LEE, Ames, IA (US)

(21) Appl. No.: 19/567,694

(22) Filed: Mar. 16, 2026

Related U.S. Application Data
(60) Provisional application No. 63/773,003, filed on Mar. 17, 2025.

(51) Int. Cl. C08G 61/10

(52) U.S. Cl. CPC C08G 61/10

(57) ABSTRACT

The present disclosure is directed to a process for preparation of a polymer comprising a moiety of Formula (I):

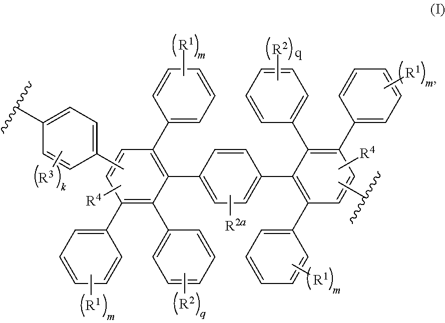

where R¹, R², R^{2a}, R³, R⁴, a, k, q, and m are as described herein.

This application claims the benefit of U.S. Provisional Patent Application Ser. No. 63/773,003, filed Mar. 17, 2025, which is hereby incorporated by reference in its entirety.

### FIELD

The present disclosure relates to poly(hexaphenyl-m,p-quaterphenylene) (PHPQP) and methods of making thereof.

### BACKGROUND

High-performance polymers (HPP) have been a subject of sustained interest since the 1950s, owing to their application in aerospace and electronics, followed by more recent applications in automotive and medical industries as the technology has matured and costs have declined. HPPs are defined by their high thermomechanical and thermochemical stability and ability to retain their desired properties under long-term exposure to harsh environmental conditions such as high temperatures (>177° C.) and chemically corrosive media (Hergenrother, P. M., “An Overview of the Use, Design, Synthesis, and Properties of High Performance/High Temperature Polymers,” High Perform Polym 15(1):3-45 (2003)). Well known HPPs include Kapton® (PI), Vespel® (PI), Ultem® (PEI), Celazole® (PBI), Victrex® (PAEK, PEEK, PEK, PEKEKK), Radel® (PPSU), Veradel® (PES), and Udel® (PSU). Fluoropolymers, such as Teflon® (PTFE), Kynar® (PVDF), and Nafion® (PFSA/PTFE), are generally recognized as HPPs for their exceptional thermochemical stability despite their lower thermomechanical stability when compared to highly aromatic HPPs. HPPs are commonly used as electrical insulators, flexible printed circuit board substrates, biocompatible medical device materials, and lightweight and corrosion-resistant structural components in all engineering applications with strict weight-reduction and durability requirements. Reliance upon HPPs is illustrated by Nafion®, which is widely recognized as a mainstay for chlor-alkali electrolysis (CAE), proton-exchange membrane fuel cells (PEMFC), and redox flow batteries (RFB) due to its combination of thermochemical stability and high conductivity.

Despite the present variety of HPP materials, there are several limitations and environmental concerns relating to existing technologies. This includes high cost compared to standard and engineering polymers, susceptibility of HPPs with heteroatomic backbones to degradation by highly acidic and alkaline media (such as those found in electrochemical applications), and growing concerns about the impacts of fluorinated polymers and their production on environmental and human health (Lohmann et al., “Are Fluoropolymers Really of Low Concern for Human and Environmental Health and Separate from Other PFAS?,” Environmental Science & Technology 54(20):12820-12828 (2020); Podder et al., “Per and Poly-Fluoroalkyl Substances (PFAS) as a Contaminant of Emerging Concern in Surface Water: A Transboundary Review of their Occurrences and Toxicity Effects,” J Hazard Mater 419:126361 (2021); Panieri et al., “PFAS Molecules: A Major Concern for the Human Health and the Environment,” Toxics 10(2):44 (2022)). The most persistently reported challenge facing HPPs arises from the same thing that makes them attractive: they are typically difficult to process due to their intrinsic thermomechanical stability and the poor solubility imparted by their highly aromatic or heavily fluorinated structures. Though many of the most recognizable HPPs require high processing temperatures and possess little to no solubility, multiple specialty formulations are developed to improve processability. These efforts are exemplified by several organosoluble polyimides and their copolymers (Xu et al., “Recent Development of Polyimides: Synthesis, Processing, and Application in Gas Separation,” Journal of Polymer Science 59(11):943-962 (2021); Huang et al., “Molecular Insight into 6FD Polyimide-Branched Poly(phenylene) Copolymers: Synthesis, Block Compatibility, and Gas Transport Study,” ACS Applied Polymer Materials 5(1):290-301 (2023); Huang et al., “6FDA-DABA Polyimide, Polyphenylene, and Polyimide-Polyphenylene Multiblock Synthesis, Characterization, and Membrane Gas Separation Performance and Modeled Transport,” Journal of Membrane Science 683:121864 (2023)), including commercially available CP1© and CORIN® XLS, which are marketed toward space-based applications such as protection of photovoltaic cells from solar ultraviolet radiation (Darwish et al., “Polymer Nanocomposite for Protecting Photovoltaic Cells from Solar Ultraviolet in Space,” Nanotechnol Rev 13(1):20240013 (2024)). Improvements in solubility are generally achieved through the introduction of trifluoromethyl, hexafluoroisopropylidene, or cardo pendants that improve flexibility and disrupt intramolecular bonding interactions between arenes, such as staggered stacking and π-teeing (Martinez, C. R. and Iverson, B. L., “Rethinking the Term “pi-stacking.”,” Chemical Science 3(7):2191-2201 (2012); Lewis et al., “Modern Computational Approaches to Understanding Interactions of Aromatics,” In Aromatic Interactions: Frontiers in Knowledge and Application, Johnson, D. W., Hof, F. Eds.; The Royal Society of Chemistry p. 1-17 (2016)). Water-soluble polyimides have also been prepared by incorporating bound ionic moieties, and their solubility has proved directly tunable by post-processing treatments (Dwivedi et al., “High-Temperature Resistant Water-Soluble Polymers Derived from Exotic Amino Acids,” RSC Advances 10(62):38069-38074 (2020)).

It is noteworthy that hydrocarbons are particularly uncommon among available HPPs, especially considering their prevalence among standard and engineering polymers. Early investigations of hydrocarbon HPPs showed promising thermal stability of p-oligophenylenes (Clar, E. Aromatische Kohlenwasserstoffe, polycyclische Systeme; Springer, 1952), but attempts at poly(p-phenylene) synthesis yielded only low molecular weight, insoluble oligomeric materials (Marvel, C. S. and Hartzell, G. E., “Preparation and Aromatization of Poly-1,3-Cyclohexadiene,” Journal of the American Chemical Society 81(2):448-452 (1959); Frey et al., “Preparation and Aromatization of Poly-1,3-Cyclohexadiene. II,” J Polym Sci Part A 1(6):2057-2065 (1963); Kovacic, P. and Koch, F. W., “Polymerization of Benzene to P-Polyphenyl by Ferric Chloride,” J Org Chem 28(7):1864-1867 (1963)). While advances have since been made concerning the synthesis of poly(p-phenylene) (Kobayashi et al., “Proton-Conducting Polymers Derived from Poly(ether-etherketone) and Poly(4-phenoxybenzoyl-1,4-phenylene),” Solid State Ionics 106(3-4):219-225 (1998); Baun et al., “Rigidification of Poly(p-phenylene)s Through o-Phenyl Substitution,” Macromolecules 53(14):5756-5762 (2020); Yoshida-Hirahara et al., “Synthesis and Investigation of Sulfonated Poly(p-phenylene)-Based Ionomers with Precisely Controlled Ion Exchange Capacity for Use as Polymer Electrolyte Membranes,” RSC Advances 10(22):12810-12822 (2020)) and polymers containing p-oligophenylene units (Chen et al., “Hydroxide Conducting Membranes with Quaternary Ammonium Cations Tethered to Poly(arylene alkylene)s via Flexible Phenylpropyl Spacers,” Chemistry of Materials 36(1):371-381 (2023); Bakvand et al., “Tuning the Performance of Poly(quaterphenyl piperidinium) Anion-Exchange Membranes by Monomer Configuration,” Adv Energy Mater 2402869 (2024); Schvval et al., “p-Oligophenylene-based polymeric fluorescent nanofilms. Synthesis, electro-optical characterization and Application in Aqueous Phase Nitroaromatic Detection,” Optical Materials 112:110737 (2021)), arguably the most consequential breakthroughs in poly(phenylene) synthesis were reported between 1966 and 1969 by Stille et al. (Stille et al., “Diels-Alder Polymerizations: Polymers Containing Controlled Aromatic Segments,” Journal of Polymer Science Part B: Polymer Letters 4(10):791-793 (1966); Mukamal et al., “Diels-Alder Polymers. III. Polymers Containing Phenylated Phenylene Units,” Journal of Polymer Science Part A-1: Polymer Chemistry 5(11):2721-2729 (1967); Stille et al., “Diels-Alder Polymers: Polyphenylenes Containing Alternating Phenylene and Triphenylphenylene Units (1),” Journal of Polymer Science Part B: Polymer Letters 7(7):525-527 (1969)).

Unlike prior attempts at transition-metal catalyzed couplings, Stille et al. took an entirely different approach to poly(phenylene) polymerization based on in situ generation of pentasubstituted phenylenes by uncatalyzed Diels-Alder cycloaddition. The reaction proceeds in two steps: firstly, the [4+2]cycloaddition of the alkyne moiety to the cyclic 1,3-diene of the cyclopentadienone moiety, followed by cheletropic elimination of carbon monoxide from the bicyclo[2.2.1]heptadienone intermediate (Perrin et al., “Glossary of Terms Used in Physical Organic Chemistry (IUPAC Recommendations 2021),” Pure and Applied Chemistry 94(4):353-534 (2022); Krompiec et al., “Diels-Alder Cycloaddition with CO, CO₂, SO₂, or N₂ Extrusion: A Powerful Tool for Material Chemistry,” Materials 15(1) (2022)). The initial report indicated excellent yield of high number average molecular weight (Mₙ) poly(phenylene) (i.e., Mₙ 32.8 kDa) (Stille et al., “Diels-Alder Polymers: Polyphenylenes Containing Alternating Phenylene and Triphenylphenylene Units (1),” Journal of Polymer Science Part B: Polymer Letters 7(7):525-527 (1969)) containing a mixture of meta and para catenation, whereby a 10 wt % solution of monomers in degassed toluene was heated to 225° C. in a Parr reactor for 30 hours. Fortuitously, the phenylated poly(phenylenes) produced by this method were transparent, highly soluble in common organic solvents (e.g., chloroform, methylene chloride, toluene, tetrahydrofuran), and thermally robust, as observed in the initial study by a degradation onset temperature (T_{d,onset}) of 550° C.

Between 1970 and the mid-2000s, further investigations into Diels-Alder poly(phenylenes) led to dendritic (Morgenroth, F. and Mullen, K., “Dendritic and Hyperbranched Polyphenylenes Via a Simple Diels-Alder Route,” Tetrahedron 53(45):15349-15366 (1997)), branched (Stumpe et al., “Novel Branched Polyphenylenes Based on A/B and AB/AB Monomers Via Diels-Alder Cycloaddition,” Macromolecular Chemistry and Physics 207(20):1825-1833 (2006); Wu et al., “From Branched Polyphenylenes to Graphite Ribbons,” Macromolecules 36(19):7082-7089 (2003); Shifrina et al., “Branched Polyphenylenes by Repetitive Diels-Alder Cycloaddition. Macromolecules 33(10):3525-3529 (2000); Rusanov et al., “2,5-Diphenyl-3,4-bis[p-(phenylethynyl)phenyl]Cyclopentadienone and Product of its Diels-Alder Homocondensation,” Russ Chem Bull. 48(5):944-948 (1999)), and hyperbranched (Morgenroth, F. and Mullen, K., “Dendritic and Hyperbranched Polyphenylenes Via a Simple Diels-Alder Route,” Tetrahedron 53(45):15349-15366 (1997)) poly(phenylenes), as well as continued studies of PHPQP and its derivatives (Shifrina et al., “Branched Polyphenylenes by Repetitive Diels-Alder Cycloaddition,” Macromolecules 33(10):3525-3529 (2000); Rusanov et al., “2,5-Diphenyl-3,4-bis[p-(phenylethynyl)phenyl]Cyclopentadienone and Product of its Diels-Alder Homocondensation,” Russ. Chem. Bull. 48(5):944-948 (1999); Stille, J. K. and Noren, G. K., “Catenation and Kinetics of the Diels-Alder Step-Growth Reaction in the Synthesis of Phenylated Polyphenylenes,” Macromolecules 5(1):49-55 (1972)). Furthermore, a thermosetting polymer (SiLK® dielectric) based on the same chemistry was developed by The Dow Chemical Company for use in low-k spin-on dielectric applications, such as those used in semiconductor fabrication (Martin et al., “Development of a Low-Dielectric-Constant Polymer for the Fabrication of Integrated Circuit Interconnect,” Advanced Materials 12(23):1769-1778 (2000)). Later reports showed PHPQP possesses a T_{d,5%} between 581-660° C. (Largier et al., “Poly(phenylene) Synthesized Using Diels-Alder Chemistry and its Sulfonation: Sulfonate Group Complexation with Metal Counter-Ions, Physical Properties, and Gas Transport,” Journal of Membrane Science 572:320-331 (2019); Fujimoto et al., “Ionomeric Poly(phenylene) Prepared by Diels—Alder Polymerization: Synthesis and Physical Properties of a Novel Polyelectrolyte,” Macromolecules 38(12):5010-5016 (2005)), a glass transition temperature (T_{g}) of 388-391° C. (Largier et al., “Poly(phenylene) Synthesized Using Diels-Alder Chemistry and its Sulfonation: Sulfonate Group Complexation with Metal Counter-Ions, Physical Properties, and Gas Transport,” Journal of Membrane Science 572:320-331 (2019); Fujimoto et al., “Ionomeric Poly(phenylene) Prepared by Diels-Alder Polymerization: Synthesis and Physical Properties of a Novel Polyelectrolyte,” Macromolecules 38(12):5010-5016 (2005)), a Young's modulus (E_{Y}) of 2.56 GPa (Largier et al., “Poly(phenylene) Synthesized Using Diels-Alder Chemistry and its Sulfonation: Sulfonate Group Complexation with Metal Counter-Ions, Physical Properties, and Gas Transport,” Journal of Membrane Science 572:320-331 (2019)), and elongation at break (ε_{b}) of 50.9% (Largier et al., “Poly(phenylene) Synthesized Using Diels-Alder Chemistry and its Sulfonation: Sulfonate Group Complexation with Metal Counter-Ions, Physical Properties, and Gas Transport,” Journal of Membrane Science 572:320-331 (2019)). Considering the collection of these properties, PHPQP performs comparably with two of the highest performance polymers in the world: Kapton® (PI) (T_{g} 360 to 410° C., T_{d,5%} 500 to 550° C., E_{Y} 2.28 to 2.62 GPa, ε_{b} 65 to 85%) and Celazole® (PBI) (T_{g} 427° C., T_{d,5%} 570° C.,³⁶ E_{Y} 5.90 GPa, ϵ_{b} 3%). This exceptional thermal, mechanical, and chemical stability and remarkable solubility in common organic solvents spurred interest in developing PHPQP derivatives as ion exchange membranes (Fujimoto et al., “Ionomeric Poly(phenylene) Prepared by Diels-Alder Polymerization: Synthesis and Physical Properties of a Novel Polyelectrolyte,” Macromolecules 38(12):5010-5016 (2005); Hibbs et al., “Synthesis and Characterization of Poly(phenylene)-Based Anion Exchange Membranes for Alkaline Fuel Cells,” Macromolecules 42(21):8316-8321 (2009)). Continued advancements in the 2010s with respect to sulfophenylated poly(phenylenes) (Skalski et al., “Structurally-Defined, Sulfo-Phenylated, Oligophenylenes and Polyphenylenes,” Journal of the American Chemical Society 137(38):12223-12226 (2015); Skalski et al., “Sulfophenylated Terphenylene Copolymer Membranes and Ionomers,” ChemSusChem 11(23):4033-4043 (2018)) ultimately resulted in the commercial release of Pemion™ in 2022 (Adamski et al., “On the Evolution of Sulfonated Polyphenylenes as Proton Exchange Membranes for Fuel Cells,” Materials Advances 2(15):4966-5005 (2021)).

Despite its promise as a highly processable HPP, unreliable and time-intensive synthesis of high molecular weight PHPQP has complicated research efforts with this material for decades. These material challenges necessitate optimizing its synthetic methodology before the scale-up of the reaction can be realized.

The present disclosure is directed to overcoming these and other deficiencies in the art.

### SUMMARY

One aspect of the present disclosure relates to a process for preparation of a polymer comprising a moiety of Formula (I):

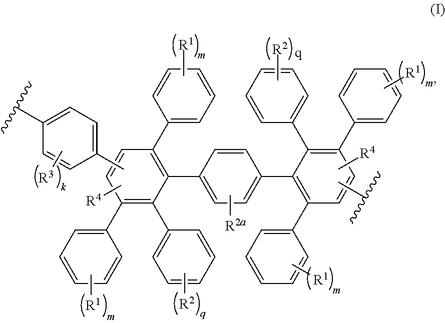

where
R¹ is independently selected at each occurrence thereof from the group consisting of H, —OH, —NH₂, halogen, —CN, NO₂, C₁₋₁₂ alkyl, OC₁₋₁₂ alkyl, SC₁₋₁₂ alkyl, —C(O)C₁₋₁₂ alkyl, —COOH, —SO₂C₁₋₁₂ alkyl, —SO₂aryl, —SO₂heteroaryl, aryl, heteroaryl, and —P(O)(OH)₂;
R² is independently selected at each occurrence thereof from the group consisting of H, —OH, —NH₂, halogen, —CN, NO₂, C₁₋₁₂ alkyl, OC₁₋₁₂ alkyl, SC₁₋₁₂ alkyl, —C(O)C₁₋₁₂ alkyl, —COOH, —SO₂C₁₋₁₂ alkyl, —SO₂aryl, —SO₂heteroaryl, aryl, heteroaryl, and —P(O)(OH)₂;
R^{2a} is independently selected at each occurrence thereof from the group consisting of H, —OH, —NH₂, halogen, —CN, NO₂, C₁₋₁₂ alkyl, OC₁₋₁₂ alkyl, SC₁₋₁₂ alkyl, —C(O)C₁₋₁₂ alkyl, —COOH, —SO₂C₁₋₁₂ alkyl, —SO₂aryl, —SO₂heteroaryl, aryl, heteroaryl, and —P(O)(OH)₂;
R³ is independently selected at each occurrence thereof from the group consisting of H, —OH, —NH₂, halogen, —CN, NO₂, C₁₋₁₂ alkyl, OC₁₋₁₂ alkyl, SC₁₋₁₂ alkyl, —C(O)C₁₋₁₂ alkyl, —COOH, —SO₂C₁₋₁₂ alkyl, —SO₂aryl, —SO₂heteroaryl, aryl, heteroaryl, and —P(O)(OH)₂;
R⁴ is independently selected at each occurrence thereof from the group consisting of H, C₁₋₁₂ alkyl, aryl, and heteroaryl;
a is 0 to 4;
k is 0 to 4;
q is 0 to 5; and
m is 0 to 5.

This method comprises:
providing a compound of Formula (II):

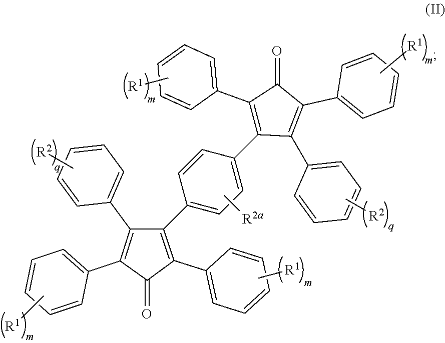

providing a compound of Formula (III):

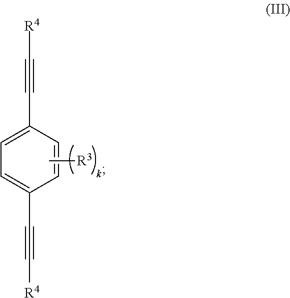

and
reacting the compound of Formula (II) with the compound of Formula (III) under ambient atmosphere to form the polymer comprising a moiety of Formula (I).

Described herein is a method for the preparation of a phenylated polyphenylene, poly(hexaphenyl-m,p-quaterphenylene) (PHPQP). PHPQP can each be prepared in less time, in a better-controlled manner, and with fewer engineering constraints than previously reported for polyphenylenes.

To develop a simpler, more robust, and timely synthetic method favorable for process scale-up, the progression of PHPQP molecular weight across multiple temperatures in air was observed, spanning six isothermal stages between 100 to 200° C. over a ten-day period.

This disclosure presents a novel catalyst-free synthesis of high molecular weight poly(hexaphenyl-m,p-quaterphenylene) (PHPQP) in air using a Diels-Alder reaction at 1 atm. The synthetic reaction was performed from 100° C. to 200° C. using a time period that covered ten days. At the end of the study, no oxidation byproducts or impurities were detected at these conditions, highlighting the method's robustness and efficiency. The process allowed for the solution-casting of creaseable films with a thickness of 75 μm at room temperature and pressure, showcasing the polymer's exceptional processing versatility. Detailed ¹H-NMR analysis revealed a unique 36:64 para-to-meta ratio of backbone phenylene moieties formed from the Diels-Alder polycondensation. The result sheds light on the reaction conditions resulting in polymer architecture. Furthermore, initial kinetic studies demonstrated non-Arrhenius behavior at temperatures above 160° C., indicating complex interactions between chain mobility, solution viscosity, and reactant diffusion that influence polymerization dynamics. This fundamental contribution contributes to the understanding of high-performance polymer synthesis and simplification to advance the path for more sustainable and scalable production methods for advanced materials.

### BRIEF DESCRIPTION OF THE DRAWINGS

FIG. 1 shows time- and temperature-dependent coloration of the reaction mixture at increasing degree of polymerization; coloration changes from red to amber.

FIGS. 2A-2B show degree of polymerization (Xₙ) as a function of time and temperature; PHPQP molecular weight and Ð (FIG. 2A) and film formation (FIG. 2B). FIG. 2C shows activation energy required for the polymerization reaction.

FIGS. 3A-3B show ¹H-NMR spectra of PHPQP with enlargement of the aromatic region (FIG. 3A) and enlargement of alkyne region (FIG. 3B).

FIGS. 4A-4B show FT-IR spectra of PHPQP with enlargement of ring mode region (FIG. 4A) and with in-plane and out-of-plane aromatic C—H bending regions enlargement (FIG. 4B).

FIG. 5 shows the results of degree of polymerization (Xₙ) and number averaged molecular weight (Mₙ) versus time (t) for each sample across the five isothermal reaction conditions.

FIG. 6 shows the results of Xₙ and Mₙ versus t for the PHPQP batches prepared at 200° C. in 1-methylnaphthalene and 1,2,4-trichlorobenzene, as compared to the PHPQP batch prepared at 200° C. in Ph₂O/Tol.

FIG. 7 shows reaction conditions yielding the highest rate and highest Mₙcompared against known literature references of Mₙ versus t for PHPQP synthesis methods.

### DETAILED DESCRIPTION

One aspect of the present disclosure relates to a process for preparation of a polymer comprising a moiety of Formula (I):

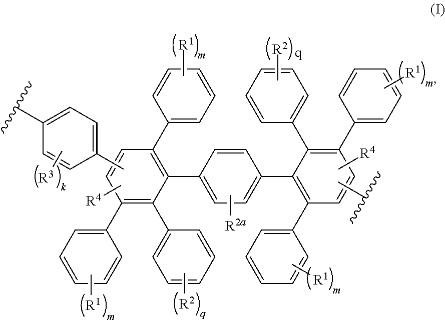

where
R¹ is independently selected at each occurrence thereof from the group consisting of H, —OH, —NH₂, halogen, —CN, NO₂, C₁₋₁₂ alkyl, OC₁₋₁₂ alkyl, SC₁₋₁₂ alkyl, —C(O)C₁₋₁₂ alkyl, —COOH, —SO₂C₁₋₁₂ alkyl, —SO₂aryl, —SO₂heteroaryl, aryl, heteroaryl, and —P(O)(OH)₂;
R² is independently selected at each occurrence thereof from the group consisting of H, —OH, —NH₂, halogen, —CN, NO₂, C₁₋₁₂ alkyl, OC₁₋₁₂ alkyl, SC₁₋₁₂ alkyl, —C(O)C₁₋₁₂ alkyl, —COOH, —SO₂C₁₋₁₂ alkyl, —SO₂aryl, —SO₂heteroaryl, aryl, heteroaryl, and —P(O)(OH)₂;
R^{2a} is independently selected at each occurrence thereof from the group consisting of H, —OH, —NH₂, halogen, —CN, NO₂, C₁₋₁₂ alkyl, OC₁₋₁₂ alkyl, SC₁₋₁₂ alkyl, —C(O)C₁₋₁₂ alkyl, —COOH, —SO₂C₁₋₁₂ alkyl, —SO₂aryl, —SO₂heteroaryl, aryl, heteroaryl, and —P(O)(OH)₂;
R³ is independently selected at each occurrence thereof from the group consisting of H, —OH, —NH₂, halogen, —CN, NO₂, C₁₋₁₂ alkyl, OC₁₋₁₂ alkyl, SC₁₋₁₂ alkyl, —C(O)C₁₋₁₂ alkyl, —COOH, —SO₂C₁₋₁₂ alkyl, —SO₂aryl, —SO₂heteroaryl, aryl, heteroaryl, and —P(O)(OH)₂;
R⁴ is independently selected at each occurrence thereof from the group consisting of H, C₁₋₁₂ alkyl, aryl, and heteroaryl;
a is 0 to 4;
k is 0 to 4;
q is 0 to 5; and
m is 0 to 5.

This method comprises:
providing a compound of Formula (II):

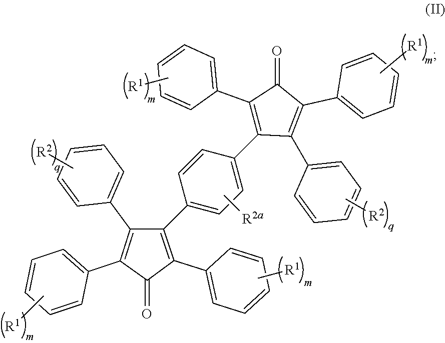

providing a compound of Formula (III):

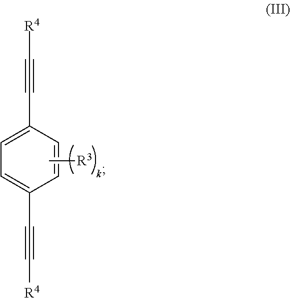

and
reacting the compound of Formula (II) with the compound of Formula (III) under ambient atmosphere to form the polymer comprising a moiety of Formula (I).

As used above, and throughout the description herein, the following terms, unless otherwise indicated, shall be understood to have the following meanings. If not defined otherwise herein, all technical and scientific terms used herein have the same meaning as is commonly understood by one of ordinary skill in the art to which this technology belongs. In the event that there is a plurality of definitions for a term herein, those in this section prevail unless stated otherwise.

In this specification and the appended claims, the singular forms “a,” “an,” and “the” include plural references unless the context clearly dictates otherwise.

The terms “comprising,” “comprises,” and “comprised of” as used herein are synonymous with “including,” “includes,” or “containing,” “contains,” and are inclusive or open-ended and do not exclude additional, non-recited members, elements, or method steps.

The terms “comprising,” “comprises,” and “comprised of” also encompass the term “consisting of” The transitional term “comprising,” which is synonymous with “including,” “containing,” or “characterized by,” is inclusive or open-ended and does not exclude additional, un-recited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed subject matter. In some embodiments or claims where the term comprising is used as the transition phrase, such embodiments can also be envisioned with replacement of the term “comprising” with the terms “consisting of” or “consisting essentially of.”

Terms of degree such as “substantially,” “about,” and “approximately” and the symbol “~” as used herein mean a reasonable amount of deviation of the modified term such that the end result is not significantly changed. These terms of degree should be construed as including a deviation of at least ±0.1% (and up to ±1%, ±5%, or ±10%) of the modified term if this deviation would not negate the meaning of the word it modifies. Unless otherwise clear from context, all numerical values provided herein are modified by the term about. All numerical values provided herein that are modified by terms of degree set forth in this paragraph (e.g., “substantially,” “about,” “approximately,” and “-”) are also explicitly disclosed without the term of degree. For example, “about 1%” is also explicitly disclosed as “1%”.

The term “and/or” as used herein means that the listed items are present, or used, individually or in combination. In effect, this term means that “at least one of” or “one or more” of the listed items is used or present.

The recitation of numerical ranges by endpoints includes all numbers and fractions subsumed within the respective ranges, as well as the recited endpoints. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member.

The term “alkyl” means an aliphatic hydrocarbon group which may be straight or branched having about 1 to about 12 carbon atoms in the chain. For example, straight or branched carbon chain could have 1 to 6 carbon atoms. Branched means that one or more lower alkyl groups such as methyl, ethyl or propyl are attached to a linear alkyl chain. Exemplary alkyl groups include methyl, ethyl, n-propyl, i-propyl, n-butyl, t-butyl, n-pentyl, and 3-pentyl.

The term “halo” or “halogen” means fluoro, chloro, bromo, or iodo.

The term “aryl” means an aromatic monocyclic or multicyclic ring system of 6 to about 14 carbon atoms, preferably of 6 to about 10 carbon atoms. Representative aryl groups include phenyl and naphthyl.

The term “heteroaryl” means an aromatic monocyclic or multicyclic ring system of about 5 to about 14 ring atoms, preferably about 5 to about 10 ring atoms, in which one or more of the atoms in the ring system is/are element(s) other than carbon, for example, nitrogen, oxygen, or sulfur. In the case of multicyclic ring system, only one of the rings needs to be aromatic for the ring system to be defined as “Heteroaryl”. Preferred heteroaryls contain about 5 to 6 ring atoms. The prefix aza, oxa, thia, or thio before heteroaryl means that at least a nitrogen, oxygen, or sulfur atom, respectively, is present as a ring atom. A nitrogen atom of a heteroaryl is optionally oxidized to the corresponding N-oxide. Representative heteroaryls include pyridyl, 2-oxo-pyridinyl, pyrimidinyl, pyridazinyl, pyrazinyl, triazinyl, furanyl, pyrrolyl, thiophenyl, pyrazolyl, imidazolyl, oxazolyl, isoxazolyl, thiazolyl, isothiazolyl, triazolyl, oxadiazolyl, thiadiazolyl, tetrazolyl, indolyl, isoindolyl, benzofuranyl, benzothiophenyl, indolinyl, 2-oxoindolinyl, dihydrobenzofuranyl, dihydrobenzothiophenyl, indazolyl, benzimidazolyl, benzooxazolyl, benzothiazolyl, benzoisoxazolyl, benzoisothiazolyl, benzotriazolyl, benzo[1,3]dioxolyl, quinolinyl, isoquinolinyl, quinazolinyl, cinnolinyl, pthalazinyl, quinoxalinyl, 2,3-dihydro-benzo[1,4]dioxinyl, benzo[1,2,3]triazinyl, benzo[1,2,4]triazinyl, 4H-chromenyl, indolizinyl, quinolizinyl, 6aH-thieno[2,3-d]imidazolyl, 1H-pyrrolo[2,3-b]pyridinyl, imidazo[1,2-a]pyridinyl, pyrazolo[1,5-a]pyridinyl, [1,2,4]triazolo[4,3-a]pyridinyl, [1,2,4]triazolo[1,5-a]pyridinyl, thieno[2,3-b]furanyl, thieno[2,3-b]pyridinyl, thieno[3,2-b]pyridinyl, furo[2,3-b]pyridinyl, furo[3,2-b]pyridinyl, thieno[3,2-d]pyrimidinyl, furo[3,2-d]pyrimidinyl, thieno[2,3-b]pyrazinyl, imidazo[1,2-a]pyrazinyl, 5,6,7,8-tetrahydroimidazo[1,2-a]pyrazinyl, 6,7-dihydro-4H-pyrazolo[5,1-c][1,4]oxazinyl, 2-oxo-2,3-dihydrobenzo[d]oxazolyl, 3,3-dimethyl-2-oxoindolinyl, 2-oxo-2,3-dihydro-1H-pyrrolo[2,3-b]pyridinyl, benzo[c][1,2,5]oxadiazolyl, benzo[c][1,2,5]thiadiazolyl, 3,4-dihydro-2H-benzo[b][1,4]oxazinyl, 5,6,7,8-tetrahydro-[1,2,4]triazolo[4,3-a]pyrazinyl, [1,2,4]triazolo[4,3-a]pyrazinyl, 3-oxo-[1,2,4]triazolo[4,3-a]pyridin-2(3H)-yl, and the like.

The term “monocyclic” used herein indicates a molecular structure having one ring.

The term “polycyclic” or “multi-cyclic” used herein indicates a molecular structure having two or more rings, including, but not limited to, fused, bridged, or spiro rings.

As used herein, the abbreviation for the polymeric product poly(hexaphenyl-m,p-quaterphenylene) (PHPQP) based on the reaction between bistetracyclone (BT) and 1,4-diethynylbenzene (DEB) is shown in Scheme 1. The nomenclature describes a repeat unit comprised of four backbone phenylenes, which alternate between penta- and 1,4-disubstituted moieties as a mixture of meta and para catenation.

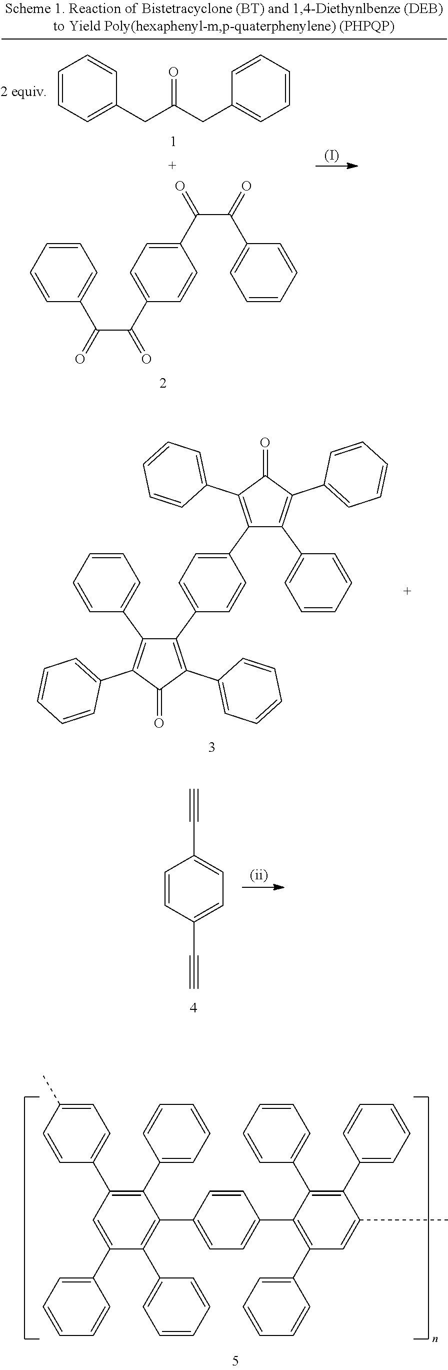

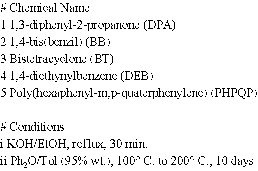

In one embodiment, the polymer comprises a moiety of Formula (IA):

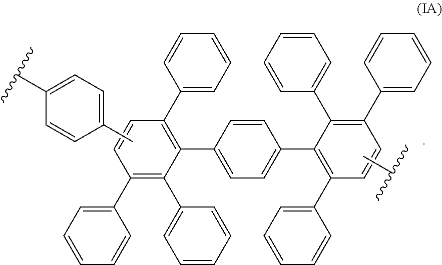

In one embodiment, the compound of Formula (II) has a Formula (IIA):

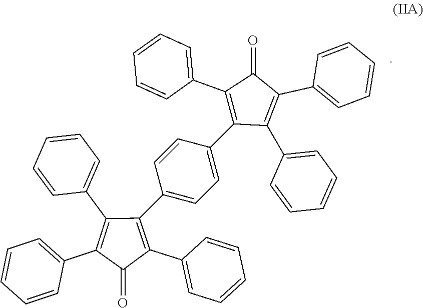 [SMILES: O=C1C(c2ccccc2)=C(c2ccccc2)C(c2ccc(C3=C(c4ccccc4)C(=O)C(c4ccccc4)=C3c3ccccc3)cc2)=C1c1ccccc1]

In one embodiment, the compound of Formula (III) has a Formula (IIIA):

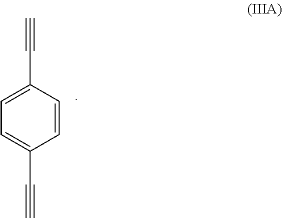

In one embodiment, the polymer comprising a moiety of Formula (I) has the structure:

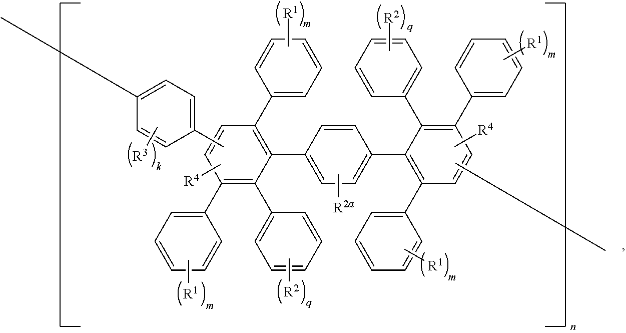

where n is 1 to 5000.

In one embodiment, the polymer comprising a moiety of Formula (I) has the structure:

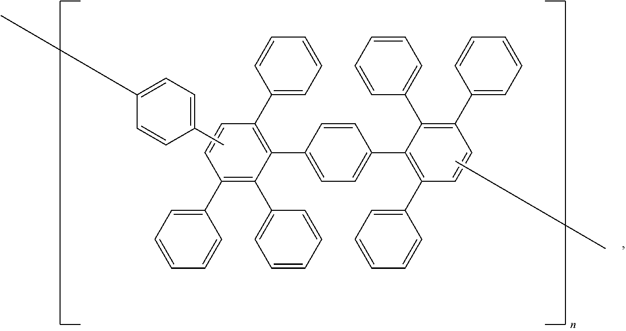

where n is 1 to 5000.

According to the present disclosure, n can be 1 to 5000, 10 to 5000, 100 to 5000, 1000 to 5000, 10 to 4000, 10 to 3000, 10 to 2000, 15 to 1000, 10 to 1000, 100 to 4000, 100 to 3000, 100 to 2000, 100 to 1000, 10 to 500, 10 to 400, 10 to 300, 10 to 200, 10 to 100, 100 to500, 100 to400, 100 to300, 100 to200, or500 to 1000.

In some embodiments, n is determined by using number average molecular weight (Mₙ), n based on number average basis. According to the present disclosure n based on number average basis can be 1 to 5000, 10 to 5000, 100 to 5000, 1000 to5000, 10 to4000, 10 to3000, 10 to2000, 15 to 1000, 10 to 1000, 100 to4000, 100 to 3000, 100 to 2000, 100 to 1000, 10 to 500, 10 to 400, 10 to 300, 10 to 200, 10 to 100, 100 to500, 100 to400, 100 to300, 100 to200, or500 to 1000.

In some embodiments, n is determined by using weight average molecular weight (Mw), n based on weight average basis. According to the present disclosure n based on weight average basis can be 1 to 5000, 10 to 5000, 100 to 5000, 1000 to 5000, 10 to 4000, 10 to 3000, 10 to 2000, 15 to 1000, 10 to 1000, 100 to 4000, 100 to 3000, 100 to 2000, 100 to 1000, 10 to 500, 10 to 400, 10 to 300, 10 to 200, 10 to 100, 100 to 500, 100 to 400, 100 to 300, 100 to 200, or 500 to 1000.

In some embodiments, n is 10 to 300 on a number average basis and 15 to 1000 on a weight average basis.

In some embodiments, n is 5 to 1000 on a number average basis and 10 to 3000 on a weight average basis.

According to the present disclosure, the polymer comprising a moiety of Formula (I) can have a number-average molecular weight (Mₙ) from about 5 kDa to about 500 kDa, from about 5 kDa to about 400 kDa, from about 5 kDa to about 300 kDa, from about 5 kDa to about 200 kDa, from about 5 kDa to about 100 kDa, from about 5 kDa to about 50 kDa, 10 kDa to about 500 kDa, from about 10 kDa to about 400 kDa, from about 10 kDa to about 300 kDa, from about 10 kDa to about 200 kDa, from about 10 kDa to about 100 kDa, from about 10 kDa to about 50 kDa, 50 kDa to about 500 kDa, from about 50 kDa to about 400 kDa, from about 50 kDa to about 300 kDa, from about 50 kDa to about 200 kDa, or from about 50 kDa to about 100 kDa.

According to the present disclosure, the polymer comprising a moiety of Formula (I) can have a weight-average molecular weight (Mw) from about 5 kDa to about 500 kDa, from about 5 kDa to about 400 kDa, from about 5 kDa to about 300 kDa, from about 5 kDa to about 200 kDa, from about 5 kDa to about 100 kDa, from about 5 kDa to about 50 kDa, from about 10 kDa to about 500 kDa, from about 10 kDa to about 400 kDa, from about 10 kDa to about 300 kDa, from about 10 kDa to about 200 kDa, from about 10 kDa to about 100 kDa, from about 10 kDa to about 50 kDa, from about 50 kDa to about 500 kDa, from about 50 kDa to about 400 kDa, from about 50 kDa to about 300 kDa, from about 50 kDa to about 200 kDa, or from about 50 kDa to about 100 kDa.

According to the present disclosure, the polymer comprising a moiety of Formula (I) can have a polydispersity (D) from about 1.2 to about 5, from about 1.2 to about 4, from about 1.2 to about 3, from about 1.5 to about 5, from about 2 to about 5, from about 2 to about 4, or from about 2 to about 3. In some embodiments, the polymer comprising a moiety of Formula (I) can have a polydispersity (D) of about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9, about 4.0, about 4.1, about 4.2, about 4.3, about 4.4, about 4.5, about 4.6, about 4.7, about 4.8, about 4.9, or about 5.0.

According to the present disclosure, the polymer comprising a moiety of Formula (I) is a mixture of meta and para catenated isomers.

As used herein the term catenation refers to the ability of an element to form chains or rings by bonding with itself, particularly prominent in carbon.

In some embodiments, the polymer comprising a moiety of Formula (I) is a mixture containing from about 25% to about 50% para and from about 50% to about 75% meta catenated isomers. For example, the polymer comprising a moiety of Formula (I) is a mixture of catenated isomers in a ratio of about 25% para to 75% meta, about 26% para to 74% meta, about 27% para to 73% meta, about 28% para to 72% meta, about 29% para to 71% meta, about 30% para to 70% meta, about 31% para to 69% meta, about 32% para to 68% meta, about 33% para to 67% meta, about 34% para to 66% meta, about 35% para to 65% meta, about 36% para to 64% meta, about 37% para to 63% meta, about 38% para to 62% meta, about 39% para to 61% meta, about 40% para to 60% meta, about 41% para to 59% meta, about 42% para to 58% meta, about 43% para to 57% meta, about 44% para to 56% meta, about 45% para to 55% meta, about 46% para to 54% meta, about 47% para to 53% meta, about 48% para to 52% meta, about 49% para to 51% meta, or about 50% para to 50% meta.

In some embodiments, the step of reacting the compound of Formula (II) with the compound of Formula (III) is carried out in the presence of a solvent. Suitable solvents that can be used include diphenyl ether (Ph₂O), benzene, toluene, chloroform, cyclohexanone, naphthalene, tetrahydrofuran, or methylated or halogenated equivalents or a mixture thereof. Suitable halogenated solvents that can be used include, without limitation, chloroform, trichlorethylene, tetrachlorethylene, methylene chloride, carbon tetrachloride, 1,1,1-trichloroethane, 1,2-dichlorobenzene, 1,3-dichlorobenzene, 1,3-dichlorobenzene, 2,4-dichlorotoluene, and 1,2,4-trichlorobenzene. Suitable methylated solvents that can be used include, without limitation, toluene, 2,4-dichlorotoluene, 2-methylcyclohexanone, 1-methylnaphthalene, and 2-methyltetrahydrofuran. In some embodiments, the solvent is 1,3-dichlorobenzene, 2,4-dichlorotoluene, 1-methylnaphthalene, and 1,2,4-trichlorobenzene.

In some embodiments, the solvent is a mixture of diphenyl ether and toluene.

In some embodiments, the solvent is a mixture of about 90 to about 99% wt of diphenyl ether and about 1 to about 10% wt of toluene. For example, the solvent is a mixture of about 90% wt of diphenyl ether and about 10% wt of toluene, about 91% wt of diphenyl ether and about 9% wt of toluene, about 92% wt of diphenyl ether and about 8% wt of toluene, about 93% wt of diphenyl ether and about 7% wt of toluene, about 94% wt of diphenyl ether and about 6% wt of toluene, about 95% wt of diphenyl ether and about 5% wt of toluene, about 96% wt of diphenyl ether and about 4% wt of toluene, about 97% wt of diphenyl ether and about 3% wt of toluene, about 98% wt of diphenyl ether and about 2% wt of toluene, or about 99% wt of diphenyl ether and about 1% wt of toluene.

According to the present disclosure, the step of reacting the compound of Formula (II) with the compound of Formula (III) can be carried out at a temperature from about 80° C. to about 220° C., about 90° C. to about 210° C., about 100° C. to about 200° C., about 110° C. to about 180° C., or about 120° C. to about 180° C. In some embodiments, the step of reacting the compound of Formula (II) with the compound of Formula (III) is carried out at a temperature of about 80° C., about 90° C., about 100° C., about 110° C., about 120° C., about 130° C., about 140° C., about 150° C., about 160° C., about 170° C., about 180° C., about 190° C., about 200° C., about 210° C., or about 220° C.

According to the present disclosure, the step of reacting the compound of Formula (II) with the compound of Formula (III) can be carried out for about 0.5 to about 48 hours, about 1 to about 46 hours, about 2 to about 44 hours, about 5 to about 40 hours, about 7 to about 45 hours, or about 10 to about 40 hours. For example it can be carried out for at least 0.5 hours, at least 1 hour, at least 2 hours, at least 3 hours, at least 4 hours, at least 5 hours, at least 6 hours, at least 7 hours, at least 8 hours, at least 9 hours, at least 10 hours, at least 11 hours, at least 12 hours, at least 13 hours, at least 14 hours, at least 15 hours, at least 16 hours, at least 17 hours, at least 18 hours, at least 19 hours, at least 20 hours, at least 21 hours, at least 22 hours, at least 23 hours, or at least 24 hours.

In some embodiments, the step of reacting the compound of Formula (II) with the compound of Formula (III) is carried out in the absence of a catalyst.

In some embodiments, the polymer comprising a moiety of Formula (I) contains no oxidation byproducts.

In some embodiments, the step of providing a compound of Formula (II) comprises:
providing a compound of Formula (IV):

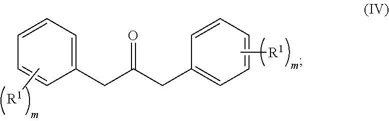

providing a compound of Formula (V):

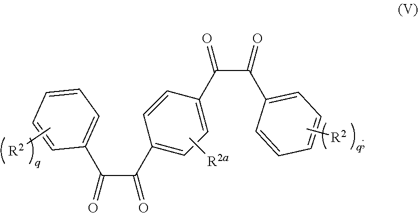

and
reacting the compound of Formula (IV) with the compound of Formula (V) under conditions to form the compound of Formula (II).

In one embodiment, the compound of Formula (IV) has a Formula (IVa):

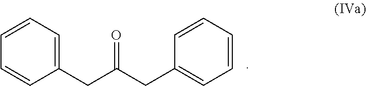 [SMILES: O=C(Cc1ccccc1)Cc1ccccc1]

In one embodiment, the compound of Formula (V) has a Formula (Va):

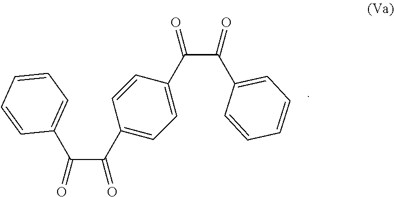 [SMILES: O=C(C(=O)c1ccc(C(=O)C(=O)c2ccccc2)cc1)c1ccccc1]

According to the present disclosure, the step of reacting the compound of Formula (IV) with the compound of Formula (V) can be carried out in the presence of a base. Suitable bases that can be used include, but are not limited to, KOH, NaOH, LiOH, and CsOH.

According to the present disclosure, the step of reacting the compound of Formula (IV) with the compound of Formula (V) is carried out in the presence of a solvent. Suitable solvents that can be used include, but are not limited to, methanol, ethanol, propanol, butanol, amyl alcohol, cyclohexanol, octanol, ethanediol, diethylene glycol, or a mixture thereof. For example, the solvent can be 1-butanol, 2-butanol, i-butyl alcohol, t-butyl alcohol, n-amyl alcohol, i-amyl alcohol, 1-hexanol or 1-octanol, or a mixture thereof.

According to the present disclosure, the step of reacting the compound of Formula (IV) with the compound of Formula (V) can be carried out at a temperature of from about 20° C. to about 120° C., about 30° C. to about 110° C., about 40° C. to about 100° C., or about 50° C. to about 90° C. For example, the step of reacting the compound of Formula (IV) with the compound of Formula (V) can be carried out at a temperature of about 20° C., about 30° C., about 40° C., about 50° C., about 60° C., about 70° C., about 80° C., about 90° C., about 100° C., about 110° C., or about 120° C.

The above disclosure is general. A more specific description is provided below in the following examples. The examples are described solely for the purpose of illustration and are not intended to limit the scope of the present disclosure. Changes in form and substitution of equivalents are contemplated as circumstances suggest or render expedient. Although specific terms have been employed herein, such terms are intended in a descriptive sense and not for purposes of limitation.

### EXAMPLES

The following Examples are presented to illustrate various aspects of the present disclosure, but are not intended to limit its scope.

### Example 1—Materials and Methods

### Materials

Acetone (Ace, 99.5%) and methanol (MeOH, 99.99%) were purchased from Barton Solvents and used as received. Anhydrous ethanol (EtOH, 99.9%), diphenyl ether (Ph₂O, 99%), methylene chloride (DCM, 99.5%), tetrahydrofuran (THF, 99.9%), and toluene (Tol, 99.5%) were purchased from Fisher Scientific and used as received. 1,4-Diethynylbenzene (DEB, 95%) was purchased from Fisher Scientific and was purified by sublimation before use. 1,3-Diphenyl-2-propanone (DPA, 99%) was purchased from Sigma-Aldrich and used as received. Deuterated methylene chloride (CD₂Cl₂; D, 99.8%) and deuterated chloroform (CDCl₃; D, 99.8%) were purchased from Cambridge Isotope Laboratories, Inc. and used as received. 1-[4-(2-Oxo-2-phenylacetyl)phenyl]-2-phenylethane-1,2-dione (bisbenzil, BB) was previously synthesized by Largier et al., “Poly(phenylene) Synthesized Using Diels-Alder Chemistry and its Sulfonation: Sulfonate Group Complexation with Metal Counter-Ions, Physical Properties, and Gas Transport,” Journal of Membrane Science 572:320-331 (2019), which is hereby incorporated by reference in its entirety, and was freshly recrystallized from EtOH prior to use. 3,3′-(1,4-Phenylene)bis(2,4,5-triphenylcyclopentadienone) (bistetracyclone, BT) was synthesized as described in Skalski et al., “Structurally-Defined, Sulfo-Phenylated, Oligophenylenes and Polyphenylenes,” Journal of the American Chemical Society 137(38):12223-12226 (2015), which is hereby incorporated by reference in its entirety. Ph₂O and Toluene were combined to produce a 95 wt % for ease of handling mixture of Ph₂O.

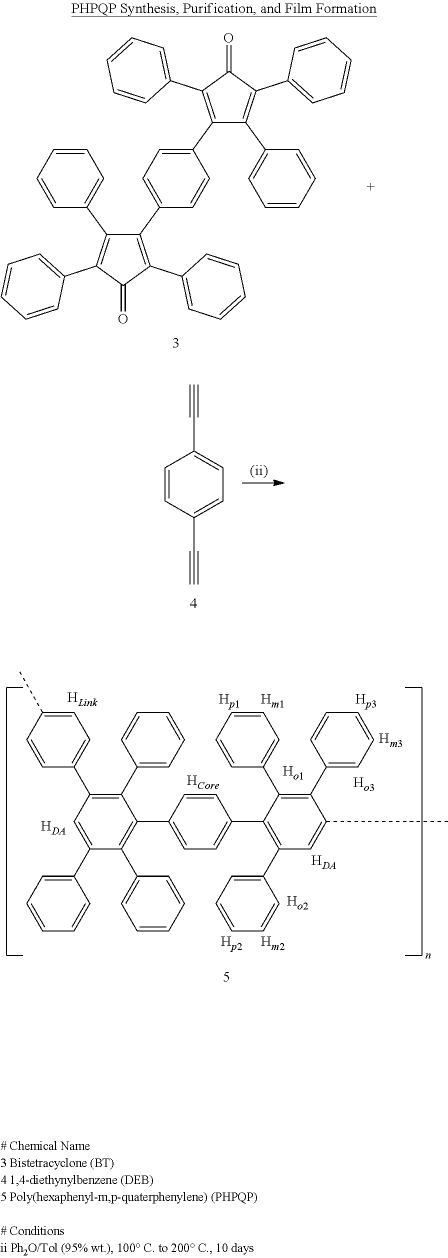

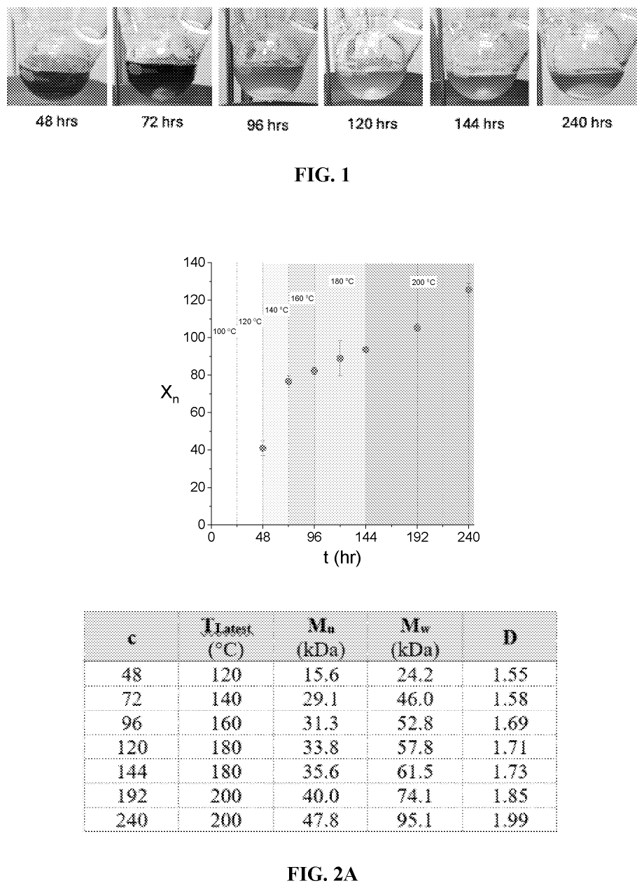

A stoichiometrically equivalent amount of BT (4.228 g, 6.120 mmol) and DEB (0.772 g, 6.120 mmol) were charged to a 100 mL three-necked round bottom flask equipped with a magnetic stir bar. Ph₂O solvent mixture (45.0 g of the 95% wt) was then added to the flask to yield a heterogeneous dark-purple mixture. The reactor was fitted with a reflux condenser and introduced to a 100° C. oil bath with stirring. The reaction proceeded in six isothermal stages over a total of ten days: 100° C. from 0 to 24 hours, 120° C. from 24 to 48 hours, 140° C. from 48 to 72 hours, 160° C. from 72 to 96 hours, 180° C. from 96 to 144 hours, and 200° C. from 144 to 240 hours. FIG. 1 shows time-dependent changes in coloration of the reaction mixture. The reaction was sampled at 48, 72, 96, 120, 144, and 192 hours by precipitation, whereby a 5.0 mL reaction mixture was added to 50 mL acetone (Ace) and cooled to 4° C. At 240 hours, the reactor was removed from the bath, and all remaining reaction mixture (~20 mL) was precipitated into 200 mL Ace and cooled to 4° C.

The PHPQP samples were filtered via vacuum filtration, dissolved in a minimum volume of THF, reprecipitated into MeOH, and filtered again to yield porous white pellets. Reprecipitation in THF and MeOH was repeated once more, and the resulting pellets were dried in vacuo for 48 hours at 60° C.

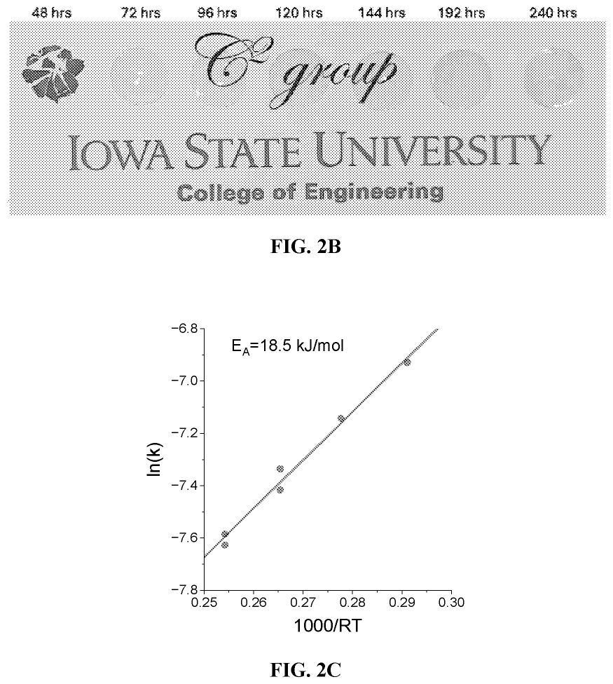

For film formation, PHPQP pellets were placed in 20 mL scintillation vials, dissolved in THF, and cast overnight at room temperature (FIG. 2B). Film thickness was controlled by varying the mass of the polymer and the solution concentration, and the evaporation rate was controlled by covering the open vials with inverted beakers. The nominal film thickness was 75 m for all film-forming samples. Films formed from different time points possess markedly different coloration, ranging from red-purple and pale pink at 48 and 72 hours, respectively, to increasing saturation of yellow as the reaction continued. Except for the brittle, red-purple film formed from the 48-hour sample, the resulting films were creaseable and transparent.

### PHPQP Molecular Weight Determination

Absolute PHPQP molecular weight and D were determined using a Waters ACQUITY advanced polymer chromatography (APC) GPC/SEC system equipped with a Malvern Omnisec Reveal (CHR6000) refractive index (RI) detector, UV-vis spectrometer, and static low-angle light scattering (LALS) and right-angle light scattering (RALS) detectors. The APC system was equipped with three linear ACQUITY APC XT columns possessing porosity of 45 Å, 125 Å, and 450 Å. This combination of columns yields a linear range of 200-400,000 Da. THF was used as the mobile phase with a column temperature of 35° C., an injection volume of 10.0 μL, and a flow rate of 0.6 mL min⁻¹. PHPQP samples were dissolved in THF to yield 2 mg mL⁻¹ solutions, which were then filtered using 0.22 μm PTFE filters before analysis. Detector constants (K_{RI}, K_{UV}, K_{LS}) for the Omnisec Reveal system were calibrated using a narrow PS standard (M_{w} 78,100; Mₙ 76,900), and the calibration was verified against a broad PMMA standard (M_{w} 93,036; Mₙ 49,317) both immediately before and following data collection.

The specific refractive index increment (dn/dc) for PHPQP was determined by APC analysis of three serially diluted PHPQP solutions in THF. The dn/dc was calculated via the OMNISEC software from the known concentrations (γ) and injection volumes (V_{Inj}) for each solution (Eq. 1), and the concentrations and observed dn/dc values for those solutions are given in Table 1.

TABLE 1
PP dn/dc Determination

| | γ | dn/dc |
|---|---|---|
| Sample | mg · mL⁻¹ | mL · mg⁻¹ |
| BS1-071-2 | 1.997 | 0.2830 |
| | | 0.2726 |
| | | 0.2690 |
| BS1-071-3 | 1.598 | 0.2715 |
| | | 0.2702 |
| | | 0.2743 |
| BS1-071-4 | 1.278 | 0.2788 |
| | | 0.2774 |
| | | 0.2758 |

$$dn / dc = \frac{RI Output ( mV )}{{K}_{RI} \cdot γ \cdot {V}_{Inj}} \qquad ( 1 )$$

The obtained dn/dc for PHPQP was 0.2747±0.0028 mL·mg⁻¹, which the OMNISEC software used for all subsequent concentration calculations (Eq. 2, as rearranged from Eq. 1) and molecular weight (M_{w}) calculations (Eq. 3).

$$γ = \frac{RI Output ( mV )}{{K}_{RI} \cdot ( dn / dc ) \cdot {V}_{Inj}} \qquad ( 2 )$$

$${M}_{w} = \frac{LS Output ( mV )}{{K}_{Ls} \cdot {( dn / dc )}^{2} \cdot γ \cdot {V}_{Inj}} \qquad ( 3 )$$

The results of the molecular weight determination are given in FIGS. 2A, 5 and 6.

### Composition and Material Characterization

Composition of PHPQP was assessed via ¹H-NMR on a Bruker Avance III 600 MHz spectrometer in CD₂Cl₂ as standardized against TMS. Fourier-transform infrared spectroscopy (FT-IR) was performed using a Thermo Fisher Nicolet iS50 FT-IR spectrometer equipped with a deuterated triglycine sulfate (DTGS) detector, and a PIKE VeeMAX III variable angle specular reflectance accessory with an ATR stage and ZnSe crystal, 45°. All IR spectra were collected at a 45° incident angle.

### Example 2—Results and Discussion for Example 1

Unfortunately, relatively few reports describe the synthetic conditions, molecular weight, and polydispersity (Ð) that exist for PHPQP, and fewer still result in Mₙ values exceeding 50 kDa. Further, BT has poor solubility in the high-temperature solvents used in the synthesis, so the generation of a stock solution of the monomer for reliable stoichiometric matching is unavailable. Only one report exists for the synthesis of PHPQP with an Mₙ of more than 100 kDa (Budy et al., “Semi-fluorinated Polyarylenes: Microwave-assisted Synthesis and Structure-property Relationships,” Journal of Polymer Science 58(19):2774-2783 (2020), which is hereby incorporated by reference in its entirety) which required either 28 days at 180° C. in an oil bath or as little as 2 hours of microwave-assisted (MWA) synthesis at 180° C. and elevated pressure, as shown in Table 2.

TABLE 2
PHPQP Reaction Conditions and Results

| Reactor | | T | t | Mₙ |
|---|---|---|---|---|
| (Atmosphere) | Solvent | (° C.) | (hr) | (kDa) |
| Parr (Vac) | Toluene | 225 | 30 | 32.8ª |
| Parr (Vac) | Toluene | 175-225 | 9-33 | 4.5-36^{b} |
| Schlenk (Ar) | Diphenyl ether/1- | 240 | 18-72 | 6.2-30.1_{c} |
| | methyl- | | | |
| | naphthalene (1:1) | | | |
| Schlenk (Ar) | Diphenyl ether | 180 | 36 | 49.6_{d} |
| Reflux | Diphenyl ether | 180 | 120 | 27ₑ |
| condenser (Ar) | | | | |
| Schlenk (Ar) | Diphenyl ether | 180 | 28 | 78.7_{f} |
| Reflux | Diphenyl ether | 180 | 28 | 78_{g} |
| condenser (Ar) | | | | |
| Reflux | Diphenyl ether | 180 | 672 | 174^{h} |
| condenser (Ar) | | | | |
| MWA (closed, Ar) | Anhydrous | 180 | 2 | 150^{h} |
| | nitrobenzene | | | |
| MWA (closed, Ar) | Anhydrous | 180 | 5 | 175^{h} |
| | nitrobenzene | | | |
| MWA (closed, Ar) | Anhydrous | 180 | 24 | 300^{h} |
| | nitrobenzene | | | |
| MWA (open, Ar) | Anhydrous | 180 | 35 | 345^{h} |
| | nitrobenzene | | | |
| Schlenk (Ar) | Diphenyl ether | 180 | 18 | 78.7ⁱ |

ªStille et al., “Diels-Alder Polymers: Polyphenylenes Containing Alternating Phenylene and Triphenylphenylene Units (1),” Journal of Polymer Science Part B: Polymer Letters 7(7): 525-527 (1969)
^{b}Stille, J. K. and Noren, G. K., “Catenation and Kinetics of the Diels-Alder Step-Growth Reaction in the Synthesis of Phenylated Polyphenylenes,” Macromolecules 5(1): 49-55 (1972)
^{c}Shifrina et al., “Branched Polyphenylenes by Repetitive Diels-Alder Cycloaddition. Macromolecules 33(10): 3525-3529 (2000)
^{d}Fujimoto et al., “Ionomeric Poly(phenylene) Prepared by Diels-Alder Polymerization: Synthesis and Physical Properties of a Novel Polyelectrolyte,” Macromolecules 38(12): 5010-5016 (2005)
^{e}Guo et al., “Asymmetric Membranes by Wet Phase Inversion of Phenylated Polyphenylene,” Journal of Applied Polymer Science 128(1): 750-753 (2013)
^{f}Largier et al., “Homopolymer and Multi-Block Diels-Alder Polyphenylenes: Synthesis, Physical Properties, X-ray Diffraction, and Gas Transport,” European Polymer Journal 89: 301-310 (2017)
^{g}Largier et al., “Poly(phenylene) Synthesized Using Diels-Alder Chemistry and its Sulfonation: Sulfonate Group Complexation with Metal Counter-Ions, Physical Properties, and Gas Transport,” Journal of Membrane Science 572: 320-331 (2019)
^{h}Budy et al., “Semi-Fluorinated Polyarylenes: Microwave-Assisted Synthesis and Structure-Property Relationships,” Journal of Polymer Science 58(19): 2774-2783 (2020)
ⁱHuang et al., “Molecular Insight into 6FD Polyimide-Branched Poly(phenylene) Copolymers: Synthesis, Block Compatibility, and Gas Transport Study,” ACS Applied Polymer Materials 5(1): 290-301 (2023)

To develop a simpler, more robust, and timely synthetic method favorable for process scale-up, the progression of PHPQP molecular weight across multiple temperatures in air, spanning six isothermal stages between 100 to 200° C. over a ten-day period was explored.

### Reaction Conditions and Kinetics of PHPQP Synthesis

When preparing the reaction mixture, it was immediately apparent that the BT monomer possessed limited solubility in the Ph₂O/Tol solvent mixture, yielding a heterogeneous, dark-purple mixture that persisted even after 24 hours at 100° C. Thus, there was limited mixing of monomers in this early stage of the reaction, resulting in an effective excess of solvated alkyne functionality relative to available cyclopentadienone. As of the 48-hour time, all solid BT had dissolved or reacted to yield a homogeneous red-purple solution. This color was discharged with a continued reaction to produce an amber-colored solution. No separation of the solvent mixture was observed throughout the first 144 hours of reaction, but toluene appeared to separate from the solvent mixture when the temperature was increased to 200° C. Its separation from the mixture was evidenced by a refluxing distillate that rapidly boiled upon reintroduction to the hot reaction vessel.

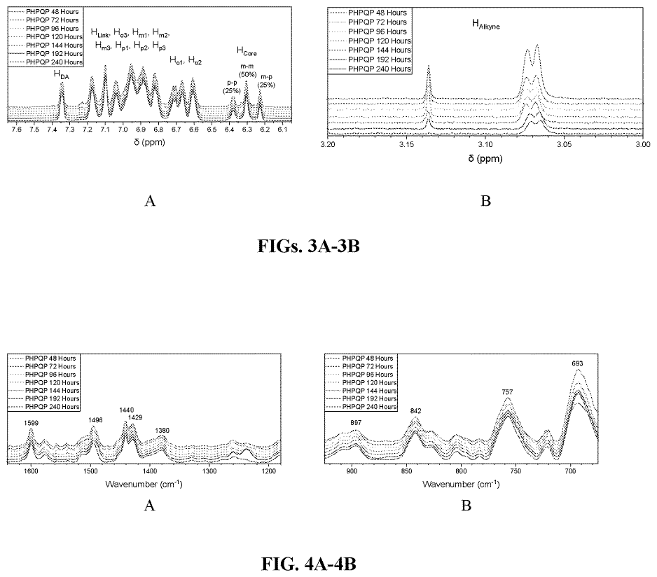

¹H-NMR spectra of PHPQP is shown in FIGS. 3A-3B. ¹H NMR (600 MHz, CD₂Cl₂) δ (ppm): 6.20-6.42 (broad overlapped signal, peaks at 6.23, 6.31, 6.38, 4H), 6.55-6.76 (broad, overlapped signal, peaks at 6.61, 6.67, 6.70, 6.72, 8H), 6.76-7.21 (broad multiplet, peaks at 6.82, 6.88, 6.95, 7.04, 7.10, 7.17, 26H), 7.32-7.37 (broad signal, peak at 7.34, 2H). The signal from 6.20-6.42 has been previously attributed to the “H_{Core}” hydrogens on the 1,4-phenylene unit from bistetracyclone (Largier et al., “Poly(phenylene) Synthesized Using Diels-Alder Chemistry and its Sulfonation: Sulfonate Group Complexation with Metal Counter-Ions, Physical Properties, and Gas Transport,” Journal of Membrane Science 572:320-331 (2019), which is hereby incorporated by reference in its entirety), which Skalski validated in the absence of the linking 1,4-phenylene unit from 1,4-diethynylbenzene (Skalski et al., “Structurally-Defined, Sulfo-Phenylated, Oligophenylenes and Polyphenylenes,” Journal of the American Chemical Society 137(38):12223-12226 (2015), which is hereby incorporated by reference in its entirety). The broad, overlapped signals from 6.55-6.76 ppm were associated with the ortho hydrogens on the phenyl pendants that are ortho to the core 1,4-phenylene unit (Largier et al., “Poly(phenylene) Synthesized Using Diels-Alder Chemistry and its Sulfonation: Sulfonate Group Complexation with Metal Counter-Ions, Physical Properties, and Gas Transport,” Journal of Membrane Science 572:320-331 (2019); Shifrina et al., “Branched Polyphenylenes by Repetitive Diels-Alder Cycloaddition. Macromolecules 33(10):3525-3529 (2000), which are hereby incorporated by reference in their entirety). The overlapping signals of the “H_{Link}” hydrogens and the remaining phenyl pendant hydrogens were observed as a broad multiplet from 6.76-7.21 ppm, and the signal at 7.34 ppm corresponded to the “H_{DA}” hydrogens on the penta-substituted rings. Small signals at 3.07 and 3.14 ppm diminished with time, correlating to H_{Alkyne} hydrogens on unreacted alkyne end-groups. Though less clearly resolved, small signals were also observed at 6.26, 6.33, 7.23, and 7.40 ppm for the phenyl pendant hydrogens on unreacted cyclopentadienone end-groups.

APC results (FIG. 2A) revealed intriguing behavior regarding both D and reaction rate (k), compared to theoretical expectations for step-growth polymerization per Carothers' theory. The Carothers equation (Eq. 4) gives Xₙ as a function of extent of reaction (p), which in turn is related to D (Eq. 5) (Young, R. J. and Lovell, P. A., “Introduction to Polymers; CRC Press, (2011), which is hereby incorporated by reference in its entirety).

$${X}_{n} = 1 / ( 1 - p ) = {c}_{o} / c = {c}_{0} kt + 1 \qquad ( 4 )$$

$$Ð = 1 + p \qquad ( 5 )$$

This relationship implied that for all observed Xₙ values of PHPQP (i.e., 41.0 to 125.6), Ð>1.9 was expected, even though this was only observed at the 240-hour time point. The result was likely due to the initial heterogeneity of the reaction mixture, as Carothers' theory assumes ideal mixing and Flory's principle of equal reactivity of functional groups (Young, R. J. and Lovell, P. A., “Introduction to Polymers; CRC Press, (2011), which is hereby incorporated by reference in its entirety). With a heterogeneous mixture, solvated stoichiometric excess of the alkynyl functionality was reasonably expected to result in an early accumulation of low Ð dialkynyl oligomers, which in turn depressed Ð until very large values of p. This was supported by the observation that D approached 2 as Xₙ>100, where by p>0.99.

Stille and Noren previously showed that PHPQP polymerization followed second-order reaction kinetics (Stille, J. K. and Noren, G. K., “Catenation and Kinetics of the Diels-Alder Step-Growth Reaction in the Synthesis of Phenylated Polyphenylenes,” Macromolecules 5(1):49-55 (1972), which is hereby incorporated by reference in its entirety). Consequently, Xₙ for PHPQP was expected to increase linearly as a function of time, assuming equal initial concentration of monomers (co) and constant temperature, as expressed in Eq. 6 (Young, R. J. and Lovell, P. A., “Introduction to Polymers; CRC Press, (2011), which is hereby incorporated by reference in its entirety).

$${X}_{n} = {c}_{0} kt + 1 \qquad ( 6 )$$

Since temperature was raised in isothermal stages throughout the reaction, k was expected to increase for each stage, assuming Arrhenius behavior (Eq. 7).

$$k = {Ae}^{\frac{- {E}_{a}}{RT}} \qquad ( 7 )$$

A significant change in k was not observed, as Xₙ increased linearly with time above 160° C. despite the increased reaction temperature. Stille, J. K. and Noren, G. K., “Catenation and Kinetics of the Diels-Alder Step-Growth Reaction in the Synthesis of Phenylated Polyphenylenes,” Macromolecules 5(1):49-55 (1972), which is hereby incorporated by reference in its entirety, previously tested whether this reaction exhibits Arrhenius behavior, but despite yielding activation parameters that are consistent with the Diels-Alder reaction, they could not confirm Arrhenius behavior due to the non-linearity of ln(k) vs. T⁻¹. They noted a scatter in their data that they attributed to the low solubility of BT and an inability to form a stock solution. They further attributed the scatter to the complexity of k, which is the sum of competing kₘₑₜₐ and kₚₐᵣₐ reaction rates; the same study showed that the ratio of those isomer-specific reaction rates has temperature dependence in a model reaction. Alternatively, the observed insensitivity of k to increased temperature may result from variation in the frequency factor (A) due to increasing viscosity with increased Xₙ and limited diffusion of the reactants. Notably, recalculation of co for the onset of each isothermal stage gave significantly better fitting Arrhenius behavior (FIG. 2C), though this required verification based on comparison of isothermal reactions and their respective rate constants.

### ¹H-NMR and FT-IR of PP

Analysis of PHPQP composition by ¹H-NMR shows resolved H_{Core} signals at 6.38, 6.31, and 6.23 ppm. These signals have been attributed to the para-para (p-p), meta-meta (m-m), and meta-para (m-p) isomers, respectively (Skalski et al., “Structurally-Defined, Sulfo-Phenylated, Oligophenylenes and Polyphenylenes,” Journal of the American Chemical Society 137(38):12223-12226 (2015), which is hereby incorporated by reference in its entirety), and their integration revealed an isomeric composition of 24%, 51%, and 25%, respectively and a 36% para to 64% meta ratio overall. The experimental result agreed with prior studies that showed the pure m-m isomer in a model reaction yields a 4H singlet corresponding to H_{Core} at 6.31 ppm (Shifrina et al., “Branched Polyphenylenes by Repetitive Diels-Alder Cycloaddition. Macromolecules 33(10):3525-3529 (2000), which is hereby incorporated by reference in its entirety), and that the meta product was favored at low temperatures (Stille, J. K. and Noren, G. K., “Catenation and Kinetics of the Diels-Alder Step-Growth Reaction in the Synthesis of Phenylated Polyphenylenes,” Macromolecules 5(1):49-55 (1972), which is hereby incorporated by reference in its entirety). The expected H_{Alkyne} signal corresponding to the DEB monomer (3.24 ppm) was absent for 48 hours, while polymeric end-group H_{Alkyne} signals at 3.07 and 3.14 ppm gradually diminished over the reaction. Notably, the signal at 3.14 ppm was absent at 240 hours, suggesting a higher relative k or greater A for that alkyne functionality compared to the alkyne functionalities indicated by the overlapped 3.07 ppm signals. The limited resolution of signals corresponding to unreacted cyclopentadienone end-group functionalities made similar comparisons more challenging, though they also diminished over time, as expected.

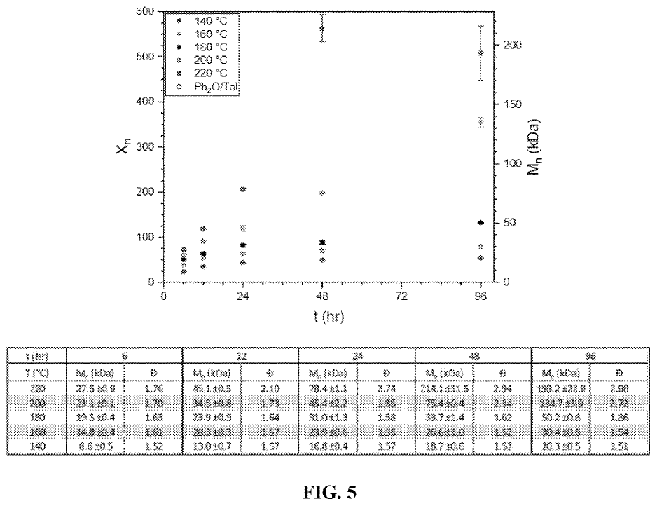

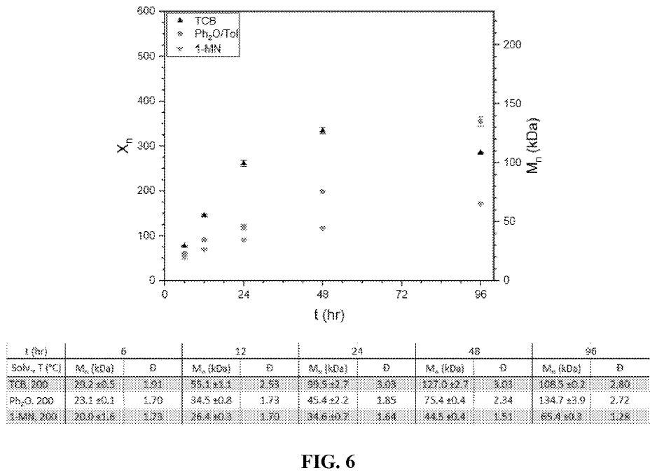

FT-IR analysis showed clear agreement with the expected composition, with aryl C—H out-of-plane stretches, and C—C in-plane stretches observed (FIGS. 4A-4B). Despite three rounds of precipitation to remove residual solvent after sampling, several samples still showed mild contamination, as evidenced by weak signals at 1236 cm⁻¹ that was attributed to the ether C—O bond in Ph₂O. Unlike ¹H-NMR, end-group signals such as C═O, C≡C, and sp C—H were absent for all samples, as characteristic signals were not observed from 1620-1680 cm⁻¹, 2100-2250 cm⁻¹, or 3300-3350 cm⁻¹, respectively. The difficulty in identifying these groups was likely due to the low sensitivity associated with ATR and the low concentration of the end-group functionalities.

The successful synthesis of high molecular weight PHPQP in air between reaction temperatures ranging from 120 to 200° C. and without evidence of oxidation byproducts or impurities is disclosed herein. The ability to synthesize PHPQP in air simplified reaction conditions and engineering constraints, reducing costs for future efforts at process scale-up. Furthermore, the use of a 95 wt % mixture of Ph₂O improved its room temperature handling concerning neat Ph₂O without hindering its viability as a solvent. Despite this, it was clear that BT has poor solubility in the Ph₂O mixture and the nature of Ph₂O as a room-temperature solid (m.p. 26.9° C.) (Haynes, W. M. e. CRC Handbook of Chemistry and Physics: A Ready-Reference Book of Chemical and Physical Data, 95th Edition 2014-2015; Ringgold, Inc, (2014), which is hereby incorporated by reference in its entirety) complicated its practical distillation from the product solution. Consequently, this necessitated the selection of a more effective reaction solvent in terms of ease of handling, reaction rate, reagent solubility, and post-synthetic processing.

¹H-NMR analysis of PHPQP indicated a 36% para to 64% meta ratio for the reported reaction conditions, which gave promising evidence in support of existing reports (Shifrina et al., “Branched Polyphenylenes by Repetitive Diels-Alder Cycloaddition. Macromolecules 33(10):3525-3529 (2000); Stille, J. K. and Noren, G. K., “Catenation and Kinetics of the Diels-Alder Step-Growth Reaction in the Synthesis of Phenylated Polyphenylenes,” Macromolecules 5(1): 49-55 (1972); which are hereby incorporated by reference in their entirety) regarding kinetic versus thermodynamic control of meta versus para catenation arising from the cycloaddition. Furthermore, initial observations concerning reaction kinetics indicate non-Arrhenius behavior above 160° C. due to the apparent insensitivity of k to increased temperature. Clarification is required by further examination of reaction kinetics and factors determining control of catenation by comparison of isothermal reactions at differing temperatures and in alternative solvents. Identifying a facile synthetic method remains a priority for advancing research and process scale-up of PHPQP. This hydrocarbon HPP showed great promise as an exceptionally processable alternative to existing HPPs in terms of thermomechanical and thermochemical stability.

### Example 3—PHPQP Synthesis at Increasing Isothermal Temperatures

Following preparation of the pure BT stock, five batches of PHPQP synthesis were conducted at incrementally increasing isothermal temperatures (i.e., 140° C., 160° C., 180° C., 200° C., and 220° C.) in a 95 percent weight mixture of diphenyl ether and toluene (Ph₂O/Tol), of which 95% of the mass of the solution was comprised of diphenyl ether with toluene as the remainder. Dilution of diphenyl ether by toluene in this fashion improved the room-temperature handling of diphenyl ether, which freezes near room temperature when not diluted by toluene in this fashion. To improve precision and consistency of stoichiometric matching for PHPQP synthesis, 625.0 g of a 4.00% wt. stock solution of 1,4-diethynylbenzene (DEB) was prepared in the Ph₂O/Tol mixture.

The five different isothermal PHPQP batches were prepared by the following procedure:
1. 22.8 g (33.0 mmol, 1.00 equivalent) of BT was charged to a 500 mL three-necked round bottom flask (reactor), followed by 104.2 g (33.0 mmol, 1.00 equivalent) of 4.00% wt. DEB solution.
2. The reactor was equipped with a magnetic stir bar and two necks were stoppered, then the reactor was affixed with an open-air condenser under circulation of tap water.
3. The reactor was introduced to an oil bath that had been preheated to the predetermined temperature (i.e., 140° C., 160° C., 180° C., 200° C., or 220° C.) and the reaction mixture was stirred at 200 RPM.
4. The reaction mixture was subsequently sampled (32 g solution) at 6 hours, 12 hours, 24 hours, and 48 hours.
5. Samples were diluted with 28 g tetrahydrofuran (THF), mixed to ensure homogeneity, and stored for purification.
6. At 96 hours, the remaining reaction mixture was quenched with 140 g THF, mixed to ensure homogeneity, and stored for purification.

Due to diphenyl ether's nature as a room-temperature solid and a high-boiling liquid (i.e., 259° C.), distillation of the Ph₂O/Tol mixture was avoided due to deposition of diphenyl ether and clogging of unheated distillation lines. Consequently, subsequent purification of (i.e., removal of Ph₂O/Tol from) PHPQP was performed as exemplified by the following procedure:
Step 1. PHPQP batches were separately precipitated by dropwise addition or pouring of the reaction mixture into 15 mL of fresh acetone per gram of reaction mixture.
Step 2. The resulting precipitate was collected by vacuum filtration and dried in an oven for a minimum of 3 hours at 60° C. and 1 mbar.
Step 3. The dried batches of precipitate were separately reconstituted in 19 g THF per gram of precipitate.
Step 4. The resulting solutions were separately precipitated again by dropwise addition or pouring into 15 mL of fresh methanol per gram of PHPQP solution.
Step 5. The resulting precipitate was collected by vacuum filtration and dried in an oven overnight (18 hours) at 60° C. and 1 mbar.
Step 6. Following oven drying, the PHPQP batches were transferred to pre-weighed jars and stored in a dark cabinet for further analysis.

A small amount of residual reaction solvent was still observed in the twice-precipitated PHPQP solids, as evidenced by corresponding signals upon ¹H-NMR analysis. One to two additional repetitions of Step 3 through Step. 6 successfully removed those traces of reaction solvent, if maximum PHPQP purity was desired.

PHPQP molecular weight distribution was assessed via gel permeation chromatography/size exclusion chromatography for each sample across the five isothermal reaction conditions, and the results of degree of polymerization (Xₙ) and number averaged molecular weight (Mₙ) versus time (t) were plotted (FIG. 5).

Two additional batches of PHPQP synthesis were conducted at 200° C. per the procedure exemplified above, although the first such batch (and its stock DEB solution) was prepared in 1,2,4-trichlorobenzene (TCB) and the second such batch (and its stock DEB solution) was prepared in 1-methylnaphthalene (1-MN). The results of Xn and Mn versus t are shown in FIG. 6, as compared to the PHPQP batch prepared at 200° C. in Ph₂O/Tol.

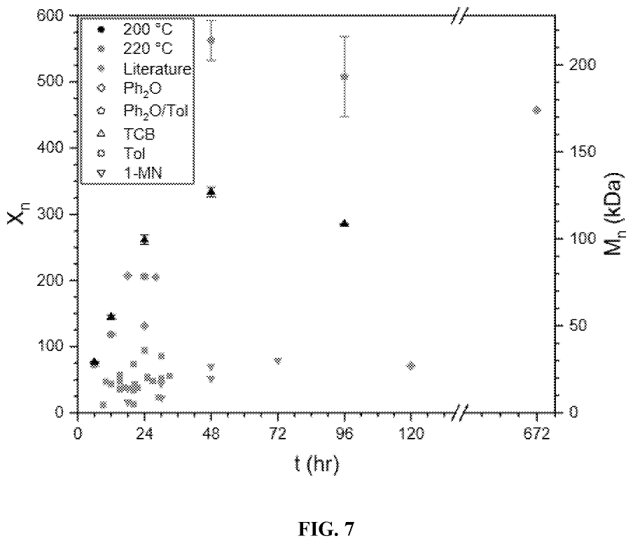

Reaction conditions yielding the highest rate and highest Mₙ were compared against known literature references of Mₙ versus t for PHPQP synthesis methods, as depicted in FIG. 7.

It is evident that PHPQP polymerization in TCB at 200° C. yielded the highest rate of reaction, reaching an Mₙ of 100 kDa in 24 hours as compared to 672 hours (Budy et al., “Semi-Fluorinated Polyarylenes: Microwave-Assisted Synthesis and Structure-Property Relationships,” Journal of Polymer Science 58(19):2774-2783 (2020), which is hereby incorporated by reference in its entirety) (the only known report of PHPQP with an Mn of 100 kDa or greater). Furthermore, maximum Mₙ values were achieved after 48 hours of reaction, as prepared in TCB at 200° C. and Ph₂O/Tol. The results were obtained via reaction in an open-air environment with no observed evidence of oxidation impurities and at yields ranging from 90% to 96%. TCB was additionally advantageous as it is both a room-temperature liquid (m.p. 16.9° C.) with a lower boiling point (214.4° C.) than that of diphenyl ether (b.p. 259° C.). This enabled its distillation from PHPQP prior to reconstitution in THF and afforded the opportunity for recycling of the TCB solvent following reaction.

It was concluded that open-air preparation of PHPQP in TCB was superior to inert-atmosphere preparation in diphenyl ether, due to the avoidance of costs and complexity associated with maintaining an inert atmosphere, improved handling of the solvent, the opportunity for solvent recycling following distillation, and increased reaction rate with respect to the established solvent, diphenyl ether. Reaction time and temperature were variable based on desired Mn, though a general method of preparation was established as 6 to 48 hours of reaction at 200° C.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

1. A process for preparation of a polymer comprising a moiety of Formula (I): 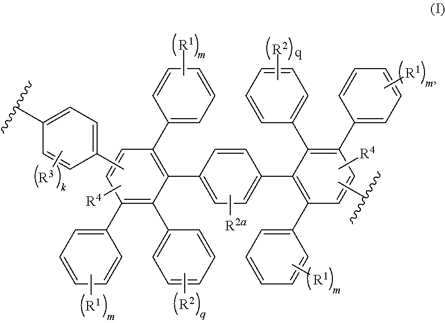
wherein
R¹ is independently selected at each occurrence thereof from the group consisting of H, —OH, —NH₂, halogen, —CN, NO₂, C₁₋₁₂ alkyl, OC₁₋₁₂ alkyl, SC₁₋₁₂ alkyl, —C(O)C₁₋₁₂ alkyl, —COOH, —SO₂C₁₋₁₂ alkyl, —SO₂aryl, —SO₂heteroaryl, aryl, heteroaryl, and —P(O)(OH)₂;
R² is independently selected at each occurrence thereof from the group consisting of H, —OH, —NH₂, halogen, —CN, NO₂, C₁₋₁₂ alkyl, OC₁₋₁₂ alkyl, SC₁₋₁₂ alkyl, —C(O)C₁₋₁₂ alkyl, —COOH, —SO₂C₁₋₁₂ alkyl, —SO₂aryl, —SO₂heteroaryl, aryl, heteroaryl, and —P(O)(OH)₂;
R^{2a} is independently selected at each occurrence thereof from the group consisting of H, —OH, —NH₂, halogen, —CN, NO₂, C₁₋₁₂ alkyl, OC₁₋₁₂ alkyl, SC₁₋₁₂ alkyl, —C(O)C₁₋₁₂ alkyl, —COOH, —SO₂C₁₋₁₂ alkyl, —SO₂aryl, —SO₂heteroaryl, aryl, heteroaryl, and —P(O)(OH)₂;
R³ is independently selected at each occurrence thereof from the group consisting of H, —OH, —NH₂, halogen, —CN, NO₂, C₁₋₁₂ alkyl, OC₁₋₁₂ alkyl, SC₁₋₁₂ alkyl, —C(O)C₁₋₁₂ alkyl, —COOH, —SO₂C₁₋₁₂ alkyl, —SO₂aryl, —SO₂heteroaryl, aryl, heteroaryl, and —P(O)(OH)₂;
R⁴ is independently selected at each occurrence thereof from the group consisting of H, C₁₋₁₂ alkyl, aryl, and heteroaryl;
a is 0 to 4;
k is 0 to 4;
q is 0 to 5; and
m is 0 to 5;
comprising:
providing a compound of Formula (II): 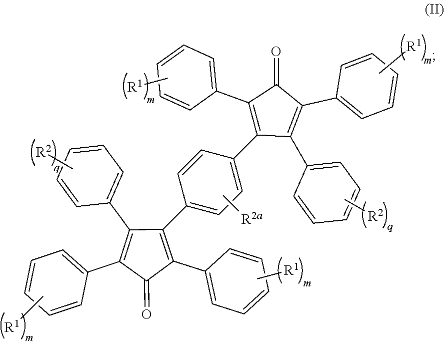
providing a compound of Formula (III): 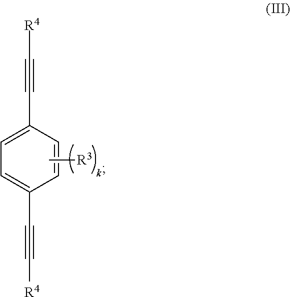
and
reacting the compound of Formula (II) with the compound of Formula (III) under ambient atmosphere to form the polymer comprising a moiety of Formula (I).

2. The process according to claim 1, wherein the polymer comprising a moiety of Formula (I) has the structure: 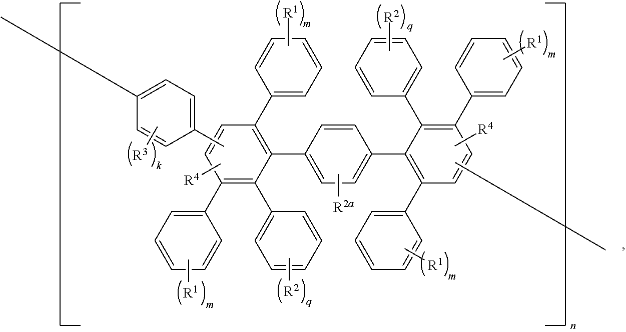
wherein n is 1 to 5000.

3. The process according to claim 2, wherein n is 10 to 300 on a number average basis and 15 to 1000 on a weight average basis.

4. The process according to claim 2, wherein n is 5 to 1000 on a number average basis and 10 to 3000 on a weight average basis.

5. The process according to claim 1, wherein the polymer comprising a moiety of Formula (I) has a number-average molecular weight (Mₙ) from about 5 kDa to about 500 kDa.

6. The process according to claim 1, wherein the polymer comprising a moiety of Formula (I) has a number-average molecular weight (Mₙ) from about 5 kDa to about 300 kDa.

7. The process according to claim 1, wherein the polymer comprising a moiety of Formula (I) has a polydispersity (Ð) from about 1.2 to about 5.

8. The process according to claim 1, wherein the polymer comprising a moiety of Formula (I) is a mixture of meta and para catenated isomers.

9. The process according to claim 1, wherein the polymer comprising a moiety of Formula (I) is a mixture containing from about 25% to about 50% para and from about 50% to about 75% meta catenated isomers.

10. The process according to claim 1, wherein the polymer comprising a moiety of Formula (I) is a mixture of catenated isomers in a ratio of about 36% para to 64% meta.

11. The process according to claim 1, wherein said reacting is carried out in the presence of a solvent.

12. The process according to claim 11, wherein the solvent comprises diphenyl ether (Ph₂O), benzene, toluene, chloroform, cyclohexanone, naphthalene, tetrahydrofuran, or methylated or halogenated equivalents or a mixture thereof.

13. The process according to claim 12, wherein the solvent is a mixture of diphenyl ether and toluene.

14. The process according to claim 13, wherein the solvent is a mixture of about 90 to about 99% wt of diphenyl ether and about 1 to about 10% wt of toluene.

15. The process according to claim 14, wherein the solvent is a mixture of about 95% wt of diphenyl ether and about 5% wt of toluene.

16. The process according to claim 1, wherein said reacting is carried out at a temperature from about 80° C. to about 220° C.

17. The process according to claim 1, wherein said reacting is carried out for at least 0.5 hours.

18. The process according to claim 17, wherein said reacting is carried out for at least 3 hours.

19. The process according to claim 1, wherein said reacting is carried out for about 0.5 to about 48 hours.

20. The process according to claim 18, wherein said reacting is carried out for about 24 hours.

21. The process according to claim 1, wherein said providing a compound of Formula (II) comprises:
providing a compound of Formula (IV): 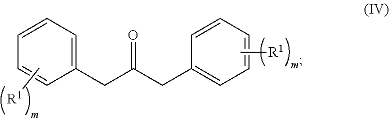
providing a compound of Formula (V): 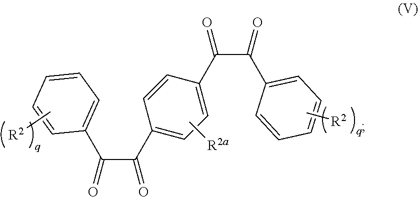
and
reacting the compound of Formula (IV) with the compound of Formula (V) under conditions to form the compound of Formula (II).

22. The process according to claim 21, wherein said reacting is carried out in the presence of a base.

23. The process according to claim 22, wherein the base is selected from the group consisting of KOH, NaOH, LiOH, and CsOH.

24. The process according to claim 21, wherein said reacting is carried out in the presence of a solvent.

25. The process according to claim 24, wherein the solvent is selected from the group consisting of methanol, ethanol, propanol, butanol, amyl alcohol, cyclohexanol, octanol, ethanediol, diethylene glycol, or a mixture thereof.

26. The process according to claim 21, wherein said reacting is carried out at a temperature of from about 20° C. to about 120° C.

27. The process according to claim 1, wherein said reacting is carried out in the absence of a catalyst.

28. The process according to claim 1, wherein the polymer comprising a moiety of Formula (I) contains no oxidation byproducts.
